(19) United States
(12) Patent Application Publication
(10) Pub. No.: US 2025/0286437 A1
(43) Pub. Date: Sep. 11, 2025

(54) Superconducting Motor with Annular Cryocooler

(71) Applicant: Hinetics, Inc., Champaign, IL (US)

(72) Inventors: Jianqiao Xiao, Champaign, IL (US); Kiruba S. Haran, Champaign, IL (US)

(21) Appl. No.: 19/047,701

(22) Filed: Feb. 7, 2025

Related U.S. Application Data
(60) Provisional application No. 63/562,829, filed on Mar. 8, 2024.

(51) Int. Cl. H02K 9/08; H02K 55/04

(52) U.S. Cl. CPC H02K 9/08; H02K 55/04

(57) ABSTRACT

A cryocooler useful for superconducting electrical machines provides an annular construction offering greater stiffness and a shorter conduction path length to superconducting coils as well the ability to provide serial and parallel assemblies of cryocoolers and passageways for ancillary power conductors.

### CROSS REFERENCE TO RELATED APPLICATION

This application claims the benefit of U.S. provisional application 63/562,829 filed Mar. 8, 2024, and hereby incorporated by reference.

### BACKGROUND OF THE INVENTION

The present invention relates to superconducting electrical machines such as motors and generators and in particular to an improved cryocooler design for such machines.

Electric motors for aerospace applications, for example, for use in aircraft, desirably provide a high specific power, that is, high-power output with light weight. Currently produced wound-field synchronous motors can provide about two kilowatts of power per kilogram of weight with a nominal efficiency of about 90 percent. Recent advances using permanent magnets have achieved specific power in excess of 13 kilowatts per kilogram with efficiencies in excess of 96 percent; however, the fault tolerance of such permanent magnet systems has not been established.

Desirably, the permanent magnets of such electric motors could be replaced with superconducting coils to provide improved efficiency and lighter weight (i.e., greater specific power). The substantial demands of standard cryogenic cooling sufficient to cool such motors, however, present a significant challenge because of the weight, complexity, and bulk of such coolers and the necessary plumbing for fluids used for heat transfer between the motor and the cooler.

U.S. patent application 17/498,294, filed Oct. 11, 2021, and assigned to the assignee of the present invention, describes an electric motor design with greatly reduced cooling demands obtained by confining the cooling to a thermally isolated rotor (which may be isolated in a rotor-specific vacuum envelope) and minimizing heat transfer between the rotor and the rotor shaft or other structures by suspending the rotor on the rotor shaft with high thermal resistance tensile spokes. The resulting reduced heat flow allows direct conductive cooling of the rotor coils using a lightweight cryocooler, for example, extending partially into the shaft and communicating with the coils through radially-extending conductive straps.

While the use of cryocoolers greatly reduces the burden of sustaining superconducting coils at the necessary temperature, integrating cryocoolers into a spinning rotor can be difficult. Aligning them along the axis of the rotor avoids imbalance problems caused by the cryocoolers but limits practical use of cryocoolers to two per shaft. Shaft-mounted cryocoolers can also block electrical wires, hydraulics, or the like which may desirably be placed through the shaft. Particularly for larger rotors, a slender cryocooler such as desirably reduces weight can be susceptible to bending torques and can unnecessarily increase a length of the cooling path to the coils on the rotor surface.

### SUMMARY OF THE INVENTION

The present invention forms the components of the cryocooler into ring shapes allowing the cryocooler diameter-to-length to be increased, increasing the cryocooler susceptibility to cross axis torque and reducing the conduction cooling path without proportional weight gains. This design also can be used to create a cryocooler with a central hollow bore allowing concentric arrangements of multiple cryocoolers for multistage cooling or independent cooling tailored to different components such as coils and heat shields. The central hollow bore also facilitates passage of internal power conductors through a superconducting electrical machine.

More specifically, in one embodiment, the invention provides a superconducting machine having a stator and a rotor, the latter having a central shaft rotatably mounted with respect to the stator to allow the rotor to rotate about a shaft axis with respect to the stator. The rotor includes a set of superconducting windings positioned on the rotor and a cryocooler aligned and fitting within the central shaft, the cryocooler having a passageway through the cryocooler extending along the shaft axis.

It is thus a feature of at least one embodiment of the invention to produce a cryocooler with an annular form factor providing improved diameter-to-length ratio without proportional weight increase.

In one embodiment, the cryocooler may provide a tubular shell having a closed cold end and an open hot end separated along the shaft axis. An annular piston fits within the tubular shell to slidably seal the open hot end, and an actuator reciprocates the piston with respect to the tubular shell. A tubular regenerator slidably fits within the tubular shell to provide a first volume between a distal end of the tubular shell and a distal end of the regenerator and a second volume between a proximal end of the regenerator and the piston, with the first and second volumes communicating through the regenerator. A gaseous heat transfer fluid is contained in the first and second volume and regenerator, and the annular piston, actuator, and tubular regenerator cooperate to provide a heat pump pumping heat from the cold end to the hot end.

It is thus a feature of at least one embodiment of the invention to adapt a general cryocooler designed to an annular configuration.

The actuator may be an electrical actuator and may also provide an armature with an open central axial bore coaxially surrounded by a coaxially inner and outer armature stator also having an open central axial bore.

It is thus a feature of at least one embodiment of the invention to provide a clear axial path completely through the cryocooler, for example, for simplified routing of power conductors or the like.

The actuator may provide coaxially arranged and separated electrical coils receiving a tubular armature connected to the piston, the tubular armature providing permanent magnets interacting with the coaxially spaced electrical coils to provide the desired reciprocation.

It is thus a feature of at least one embodiment of the invention to provide an improved efficiency actuator having opposed coils on opposite sides of the tubular armature.

In some embodiments, the armature stator may be stationary with respect to the stator of the superconducting machine.

It is thus a feature of at least one embodiment of the invention to permit for direct wire, rather than wireless, connection to the armature stator.

The superconducting machine may further include a power conduit, such as one or more electrical, pneumatic, or hydraulic lines, passing through the passageway of the cryocooler.

It is thus a feature of at least one embodiment of the invention to provide a convenient path through or into the shaft of the superconducting machine for power transmission, for example, that may be used for propeller feathering.

The superconducting machine may include a second cryocooler aligned with the central shaft, the second cryocooler fitting coaxially within the passageway of the cryocooler.

It is thus a feature of at least one embodiment of the invention to simplify the use of more than two cryocoolers while maintaining axial alignment of the cryocoolers minimizing centrifugal acceleration on the cryocooler components.

Each cryocooler may have a cold end for absorbing heat and a hot end for expelling heat, and the cold end of the second cryocooler may be thermally connected to the hot end of the first cryocooler.

It is thus a feature of at least one embodiment of the invention to permit a series connection of cryocoolers, for example, to obtain lower temperatures.

In some embodiments, the cold end of the first cryocooler and concentric second cryo-coolers may provide for independent cold ends, for example, with the cold end of the first cryocooler attached to electrical coils of the stator and the cold end of the second cryocooler thermally attached to a thermal shield positioned between the central shaft and the electrical coils of the stator.

It is thus a feature of at least one embodiment of the invention to permit parallel operation of coaxial cryocoolers intended for structures with, for example, different temperatures or heatsink requirements.

The central shaft of the rotor may provide a hollow bore receiving the cryocooler to provide a continuous passage between opposite sides of the rotor through the cryocooler.

It is thus a feature of at least one embodiment of the invention to provide an actual path through the electrical machine for routing of cables carrying electricity or pneumatic or hydraulic pressure.

The central shaft provides a hollow bore receiving the cryocooler and further including a coaxially centered tubular conduit within the passageway of the cryocooler, and wherein the tubular conduit and hollow bore cooperate to establish a sealed evacuated volume holding the cryocooler.

It is thus a feature of at least one embodiment of the invention to position the cryocooler in an evacuated space for reduced heat transmission and improved communication with a remainder of the rotor structure.

The cold end of the cryocooler maybe insulated from an outer surface of the tubular conduit.

It is thus a feature of at least one embodiment of the invention to minimize heat transfer from the ambient air through the tubular conduit to the cryocooler.

The central shaft may provide a hollow bore receiving the cryocooler, and the cryocooler and the hollow bore of the shaft of the motor may receive and support the cold end.

It is thus a feature of at least one embodiment of the invention to provide a support of the cold end of the cryocooler limiting the need for close thermal contact to an interior channel through the cryocooler to stabilize the end of the cryocooler.

These particular objects and advantages may apply to only some embodiments falling within the claims and thus do not define the scope of the invention.

### BRIEF DESCRIPTION OF THE DRAWINGS

FIG. 1 is a simplified exploded view of the principal components of a motor constructed according to the present invention including a stator and a concentrically rotating wound-field rotor within a vacuum envelope having an axially mounted cryocooler with a hollow bore;

FIG. 2 is a perspective view the cryocooler of FIG. 1 showing an annular regenerator and annular piston and actuator;

FIG. 3 is a vertical plane cross-section of the assembled cryocooler of FIG. 2;

FIG. 4 is a Carnot diagram of the operation of the cryocooler;

FIG. 5 is a block diagram of concentrically arranged cryocoolers for serial operation;

FIG. 6 is a fragmentary perspective view of concentrically arranged cryocoolers for parallel operation; and

FIG. 7 is a cross-sectional view of the cryocooler within a hollow motor shaft showing containment of the cryocooler within an evacuated chamber about a passageway communicating with ambient air.

### DETAILED DESCRIPTION OF THE PREFERRED EMBODIMENT

### Cryocooler Environment

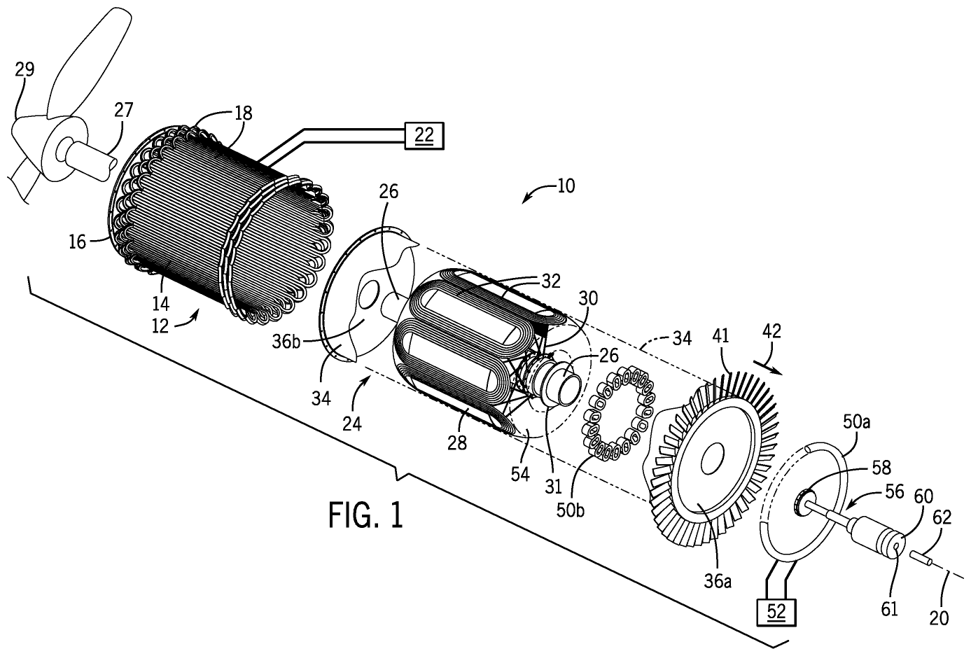

Referring now to FIG. 1, a superconducting motor 10 per the present invention may include a stator 12 providing, in one embodiment, a generally cylindrical, tubular stator form 14 having an outwardly flared end 16. A set of stator coils 18 may be attached to an inner surface of the stator form 14 spaced angularly about an axis 20 of the stator form 14 and extending between its opposite ends to provide a radially directed magnetic axis. The stator coils 18 may be air-core coils stabilized in a potting material as attached to the stator form 14 and may communicate with a motor drive circuit 22, for example, sequentially energizing the stator coils 18 to create a rotating magnetic field about the axis 20 as is generally understood in the art.

Fitting within the stator form 14 to rotate therein about the axis 20 is a rotor 24 providing a tubular rotor shaft 26 that may communicate beyond the confines of the motor 10 as a driveshaft 27 connected, for example, to a turbine or propeller system 29 of an aircraft or the like (not shown). The propeller system 29 may provide an internal mechanism driven, for example, by hydraulic fluid to feather or change the pitch of the propeller blades. The rotor shaft 26 may be supported for rotation on bearings 31.

A rotor shell 28 is positioned concentrically around the shaft 26 and held for co-rotation with the shaft 26 by a set of thermally insulated spokes 30 radiating outwardly from the shaft 26 as will be discussed in more detail below. The rotor shell 28 may be a polygonal tube, for example, having an inner and outer circumference describing rotationally aligned regular polygons of cross-section, for example, with eight planar faces. The rotor shell 28 may be constructed of aluminum, or other lightweight material, to have low weight and low moment of inertia and will typically have a radial thickness of less than 100th of the radius of the rotor shell 28 from the axis 20.

An outer surface of the rotor shell 28 includes a set of rotor coils 32 having an elongate racetrack shape and, more specifically, following the shape of a geometric stadium being a rectangle with semicircles at opposite ends, with a longest dimension extending between axial ends of the rotor shell 28. The rotor coils 32 will be spaced circumferentially around the rotor shell 28 at equal angular intervals and may be air-core planar coils, the latter term, as used herein, meaning that the coils are substantially two-dimensional being wound helically in one or a limited number of layers to conform to a surface. Generally, the rotor coils 32 will be high-temperature superconductive materials so as sustain a strong magnetic field without significant power consumption in the manner of a permanent magnet but with much lower mass and hence weight. Generally, the rotor coils 32 may be infused with a stabilizing polymer or epoxy material.

Referring still to FIG. 1, a cylindrical vacuum envelope 34 closely surrounds the rotor shell 28 and includes end caps 36a and 36b providing bases to the cylinder and sealing the ends of the vacuum envelope 34 against the outer circumference of the shaft 26 to provide an airtight volume 38 that may be evacuated to reduce convective heat loss between the rotor shell 28 and outside structures of the motor and between the rotor shell 28 and the shaft 26. End cap 36b may have a radially outwardly extending impeller 41 pulling air, as indicated by airflow 42, over the outer surface of the stator form 14 for cooling of the same as the rotor 24 rotates.

Positioned on either side of end cap 36a are wireless transmission coils 50a and 50b forming primary and secondary windings of a transformer for transferring power through the vacuum envelope 34 without breach thereof to provide excitation power to the rotor coils 32. Coil 50 may be energized by a high-frequency power source 52, and coil 50b may communicate with the rotor coils 32 by means of a power conditioner 54 providing solid-state rectification and filtering of the alternating current transferred between the transmission coils 50a and 50b to produce the necessary DC voltages for the rotor coils 32. Other systems for wirelessly providing current to the coils 32 include contactless flux pumps of a type known in the art.

### Cryocooler

In one embodiment, the cryocooler 56 may extend along the axis 20 and have a cold end 58 passing into the hollow tubular shaft 26 to be roughly centered within the ends of the rotor 24 and attached to the shaft 26 by insulating supports to rotate therewith as will be described below. A hot end 60 of the cryocooler 56 may extend outside of the vacuum envelope 34 and be attached to a heatsink or the like. The actuation of the cryocooler 56 provides a Stirling cycle heat pump pumping heat from the cold end 58 to the hot end 60 (the latter at ambient temperatures) to bring the temperature of the cold end 58 to cryogenic temperatures of less than 50° Kelvin.

The cryocooler 56 provides an annular form offering a central passageway 61 aligned with the axis 20 to allow the passage of a power conduit 62 therethrough, the power conduit 62 being variously one or more electrical conductors, pneumatic lines, or hydraulic lines that may transmit power. In one embodiment, the power conduit is a hydraulic line used to actuate a mechanism of the propeller system 29 for feathering the propeller blades; however, power conduits 62 for other purposes are also contemplated.

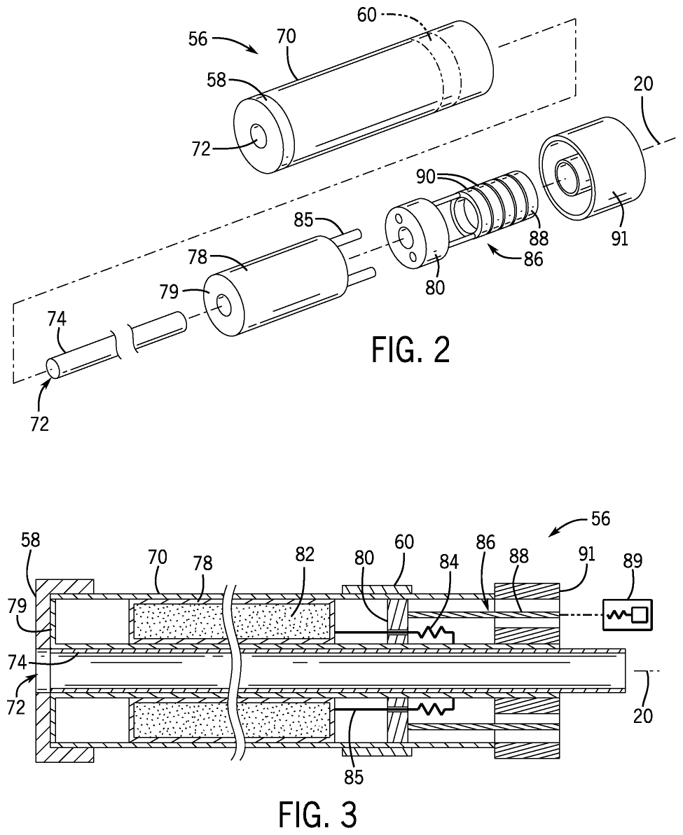

Referring now to FIGS. 2 and 3, the cryocooler 56 may provide an outer tubular housing 70 having the cold end 58 at a distal end of the outer tubular housing 70 and the hot end 60 near the proximal end of the outer tubular housing 70. The cold end 58 provides an axial bore 72 matching a diameter of a coaxially centered tubular conduit 74, together providing a passageway extending the full length of the shaft 26 through the shaft 26 and contained cryocooler 56.

An annular regenerator 78 is slidably received around the tubular conduit 74 and within the outer tubular housing 70 to move axially therein while conducting axial movement of gas through the annular regenerator 78. The regenerator 78 provides a heat exchanger medium 82 that can absorb heat or release heat to gas passing therethrough.

An annular piston 80 is positioned on a proximal side of the annular regenerator also around the tubular conduit 74 and within the outer tubular housing 70. The annular piston 80 may sealably slide within the outer tubular housing to compress (or decompress) gas in a space between a distal end of the annular piston cylinder 76, closed by an annular cap 79, and the piston 80. The contained gas provides a working fluid for heat transfer, for example, helium.

The slidable regenerator 78 may communicate with a spring 84 giving it a natural axial resonant frequency caused by a combination of the mass of the regenerator 78 and the spring constant of the spring 84. In one embodiment, the regenerator 78 may communicate with the spring 84 by means of one or more shafts 85 passing through the piston 80 to the spring 84 which has its remaining end anchored with respect to the outer tubular housing 70.

The piston 80 may communicate with an electrical actuator having an armature assembly 86 with a tubular magnet support 88 providing a set of axially aligned and spaced ring magnets 90. The tubular magnet support 88 may fit within a linear motor stator 91 that may be energized to produce an oscillation of the piston 80 at a frequency corresponding to the natural resonant frequency of motion of the regenerator 78. The linear motor stator 91 may support coils adjacent to an inner and outer surface of the tubular magnet support 88 interacting with the magnets 90, for example, in the manner of a stepper motor. Generally the actuator will be attached to and thus with be stationary with respect to the remainder of the cryocooler 56; however, it is also contemplated that the stator of the actuator may be fixed with respect to the stator 12 to eliminate the need for wireless coupling.

The armature assembly 86 may be attached to a spring mass damper 89 operating to reduce vibration of the entire cryocooler 56.

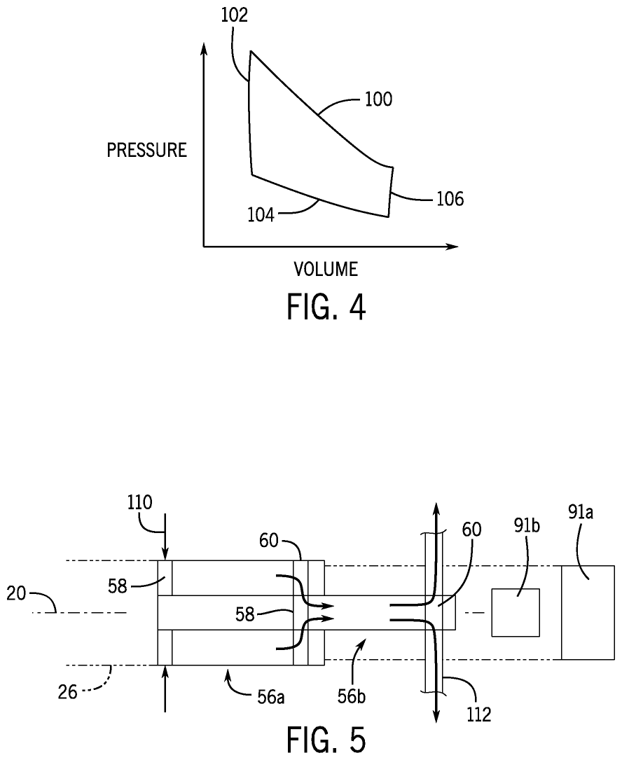

Referring now to FIG. 4, when the stator 91 is operated at the appropriate frequency, motion of the piston 80 and the regenerator 78 within the tubular housing 70 implement a Stirling cycle having the following stages:
(1) Isothermal compression 100, where the volume between the piston 80 and the proximal end of the regenerator 78 decreases ejecting heat from the hot end 60 into ambient air typically through a heatsink;
(2) Isochoric cooling 102, where gas flows through the regenerator 78 from the hot end 60 between the piston 80 and the proximal end of the regenerator 78 to the cold end 58 at a volume between the annular caps 79 and the distal end of the regenerator 78;
(3) Isothermal expansion 104, where the volume between the annular cap 79 and the distal end of the regenerator 78 at the cold end 58 increases allowing the gas to expand and absorb heat from the region at the cold end 58; and
(4) Isochoric heating 106, where gas flows through the regenerator 78 from the cold end 58, between the annular cap 79 and the distal end of the regenerator 78, to the hot region between the proximal end of the regenerator 78 and the piston 80.

The four stages of this cycle are repeated at a high rate, for example, 60 times per second.

Referring now to FIG. 5, the disclosed construction of the cryocooler 56 allows for a first cryocooler 56a to fit coaxially about a second cryocooler 56b, the latter of which will also typically but need not be constructed with a central through passageway. The hot end 60 of the cryocooler 56a may be in close thermal communication with the cold end 58 of the cryocooler 56b allowing the cryocoolers 56 to operate in series, with heat flow 110 passing into the cold end 58 of the cryocooler 56a, and then from the hot end 60 of the cryocooler 56a to the cold end 58 of the cryocooler 56b, and finally be expelled through heatsinks 112 attached to the hot end 60 of the cryocooler 56b, the latter typically positioned outside of the motor shaft 26.

Each of the cryocoolers 56a and 56b may have separate stators 91a and 91b to operate at a desired power level and frequency tailored for optimal heat flow and the different sizes and masses of the respective cryocooler components. Such a multi-stage serial connection can provide for a greater temperature drop between the ends of the serially connected cryocoolers 56.

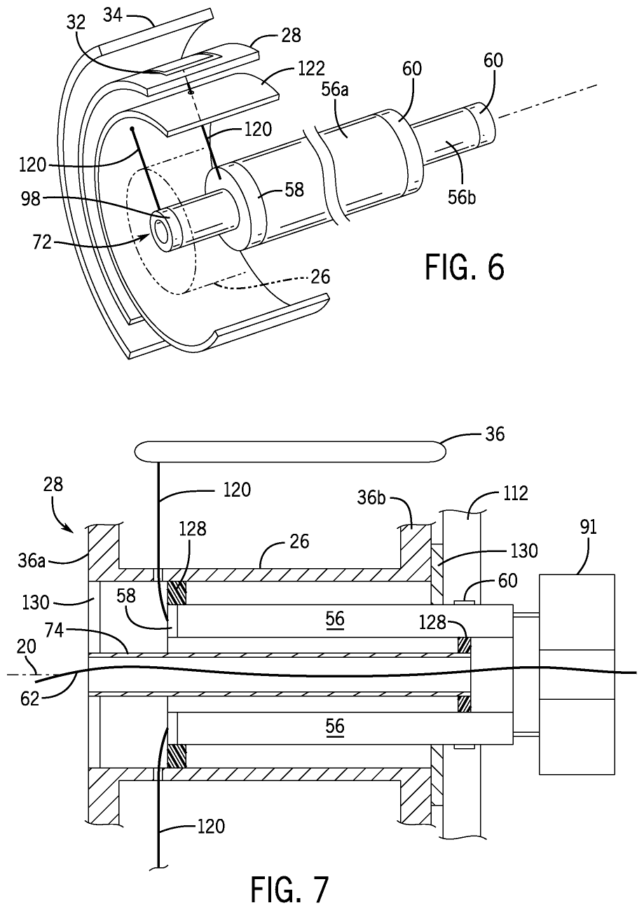

Referring now to FIG. 6, in an alternative, parallel configuration, the cryocooler 56b may operate in parallel with the cryocooler 56a, the latter, as before, arranged concentrically around the former. Each of the cryocoolers 56a and 56b may have separate or thermally connected hot ends 60 for expelling heat into the ambient environment. The cold ends 58 of the cryocoolers 56a and 56b, however, will be separate to provide separate thermal paths to different structures to be cooled. In one example, the cryocooler 56a may have its cold end 58 connected by a thermally conductive strap 120 to an intermediate cylindrical heat shield 122 positioned between the rotor shell 28 and supported coils 32 and the shaft 26. This cryocooler 56b may be set up to provide a different temperature to its cold end 58 and a different heat flow rate than the cryocooler 56a as may be suitable for the structure of the cylindrical heatshield 122. In contrast, the cryocooler 56a may have its cold end 58 connected by a thermal strap 120 to a coil 32 on the outer circumference of the rotor shell 28 to preserve cryogenic current flow in those coils 32.

Referring now to FIG. 7, the cold end 58 of a cryocoolers 56 may in some embodiments be spaced from the center tubular conduit 74 which may provide a continuous passage between opposite ends of the shaft 26 and opposite sides of the end caps 36 and vacuum envelope 34. Generally this center tubular conduit 74 will communicate directly with ambient air thus facilitating passage of power conduits 62 as discussed above. In one embodiment, the distal end of the cryocoolers 56 may be braced against the inner surface of a hollow shaft 26, for example, by a support ring 126, for additional stability against cross axis torque. The proximal end of the cryocooler 56 may be supported by an insulating spacer ring 128 extending between the inner radius of the bore of the cryocooler 56 and an outer surface of the center tubular conduit 74.

The space between the outer surface of the tubular conduit 74 and the inner surface of the shaft 26 may be isolated by vacuum seals 130 so that this space can be evacuated and the cryocooler 56 thermally isolated from ambient air within the tubular conduit 74. The maintenance of this vacuum also allows for a leak-free passage from the cold end 58 of the cryocooler through the shaft 26, for example, to coils 32 or an intermediate shield through the evacuated space around the shaft 26.

Additional details of construction of electrical machines suitable for use with the present invention may be found in US Patent publications 2024/0014709, published Jan. 11, 2024, and 2022/0302816, published Sep. 22, 2022, assigned to the assignee of the present invention, and hereby incorporated by reference. Additional details and design options for cryocoolers are found generally in R. Unger, “The development of the CRYOTEL™ LT and Gt,” AIP Conference Proceedings, 2006. doi:10.1063/1.2202599; J. Xiao, Y. Zhao, R. Dutta, and K. Haran, “Rotating cryocooler performance for superconducting rotor,” 2023 IEEE Power and Energy Conference at Illinois (PECI), March 2023, doi:10.1109/peci57361.2023.10197681; and R. W. Dyson, P. Passe, K. P. Duffy, and R. Jansen, “High efficiency megawatt motor rotating cryocooler conceptual design,” AIAA Propulsion and Energy 2019 Forum, August 2019. doi:10.2514/6.2019-4515, all hereby incorporated by reference.

As used herein, the term rotor may refer to either a rotational motor/generator element or a linear motor/generator element often referred to as a secondary in contrast to a stator which is often referred to as a primary. Similarly the term stator may refer either to functionally similar structures conventionally used in a rotational or linear motor/generator. Thus, while the above description is generally focused on the construction of a motor, it will be appreciated that the same principles will produce an electrical generator and thus the invention generally involves an electrical machine rather than a motor or generator particularly.

It is contemplated that the cryocooler may generally be according to a variety of non-Joule Thompson type coolers, including pulse-tube cooler, Stirling coolers and the like.

Certain terminology is used herein for purposes of reference only and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A superconducting machine comprising:
a stator; and
a rotor having a central shaft rotatably mounted with respect to the stator to allow the rotor to rotate about a shaft axis with respect to the stator, wherein the rotor includes:
a set of superconducting windings positioned on the rotor; and
a cryocooler aligned and fitting within the central shaft, the cryocooler having a passageway through the cryocooler extending along the shaft axis.

2. The superconducting machine of claim 1 wherein the cryocooler provides:
a tubular shell having a closed cold end and an open hot end separated along the shaft axis;
a tubular regenerator fitting within the tubular shell to provide a first volume between a distal end of the tubular shell and a distal end of the regenerator and a second volume between a proximal end of the regenerator and the piston, the first and second volumes communicating through the regenerator; and
a gaseous heat transfer fluid contained in the first and second volume and regenerator;
a compressor communicating with the second volume to cyclically compress the gaseous heat transfer fluid in the second volume;
wherein the tubular shell, tubular regenerator, gaseous heat transfer fluid, and compressor cooperate to provide a heat pump pumping heat from the cold end to the hot end.

3. The superconducting machine of claim 2 wherein the compressor provides an annular piston fitting within the tubular shell to slidably seal the open hot end and an actuator for reciprocating the piston with respect to the tubular shell.

4. The superconducting machine of claim 3 wherein the actuator is an electrical actuator and provides an armature with an open central axial bore coaxially surrounded by a coaxially inner and outer armature stator also having an open central axial bore.

5. The superconducting machine of claim 4 wherein the actuator provides coaxially arranged and separated electrical coils receiving a tubular armature connected to the piston, the tubular armature providing permanent magnets interacting with the coaxially spaced electrical coils to provide a reciprocation of the tubular armature.

6. The superconducting machine of claim 5 wherein the armature stator is stationary with respect to the stator.

7. The superconducting machine of claim 1 further including a power conduit passing through the passageway of the cryocooler.

8. The superconducting machine of claim 7 wherein the power conduit is selected from the group consisting of electrical, pneumatic, and hydraulic lines.

9. The superconducting machine of claim 7 further including a propeller attached to the central shaft providing pitch-adjustable blades according to power received by the power conduit.

10. The superconducting machine of claim 1 further including a second cryocooler aligned with the central shaft, the second cryocooler fitting coaxially within the passageway of the cryocooler.

11. The superconducting machine of claim 10 wherein second cryocooler provides a passageway through the second cryocooler aligned with the shaft axis.

12. The superconducting machine of claim 10 wherein the cryocooler and second cryocooler each have cold ends for absorbing heat and hot ends for expelling heat and wherein the cold end of the second cryocooler is adapted to draw heat from the hot end of the cryocooler through a thermal connection.

13. The superconducting machine of claim 10 wherein the cryocooler and second cryocooler each have cold ends for absorbing heat and hot ends for expelling heat and wherein the cold end of the one of the cryocoolers and second cryocooler is thermally attached to electrical coils of the stator and a cold end of another of the cryocoolers and second cryocooler is thermally attached to a thermal shield positioned between the central shaft and the electrical coils of the stator.

14. The superconducting machine of claim 1 wherein the central shaft provides a hollow bore receiving the cryocooler to provide a continuous passage between opposite sides of the rotor through the cryocooler.

15. The superconducting machine of claim 1 wherein the central shaft provides a hollow bore receiving the cryocooler and further including a coaxially centered tubular conduit within the passageway of the cryocooler and wherein the tubular conduit and hollow bore cooperate to establish a sealed evacuated volume holding the cryocooler.

16. The superconducting machine of claim 15 wherein the cold end of the cryocooler is insulated from an outer surface of the tubular conduit.

17. The superconducting machine of claim 1 wherein the central shaft provides a hollow bore receiving the cryocooler and the cryocooler has an axially separated hot end and cold end, and the hollow bore of the shaft receives and supports the cold end.
